(19) United States
(12) Patent Application Publication
(10) Pub. No.: US 2013/0056979 A1
(43) Pub. Date: Mar. 7, 2013

(54) HOLDING DEVICE FOR SENSORS FOR HIGH-PRESSURE APPLICATIONS

(71) Applicants: Ulrich REBER, Mutterstadt (DE); Harald Hahn, Gruenstadt (DE); Frank Raue, Ludwigshafen (DE); Thomas Müller, Biblis (DE)

(72) Inventors: Ulrich REBER, Mutterstadt (DE); Harald Hahn, Gruenstadt (DE); Frank Raue, Ludwigshafen (DE); Thomas Müller, Biblis (DE)

(73) Assignee: BASF SE, Ludwigshafen (DE)

(21) Appl. No.: 13/602,643

(22) Filed: Sep. 4, 2012

Related U.S. Application Data
(60) Provisional application No. 61/531,659, filed on Sep. 7, 2011.

(51) Int. Cl. F16L 15/04

(52) U.S. Cl. 285/355

(57) ABSTRACT

Device for connecting a sensor, which has a conical sealing cone and an external screwthread in front of the sealing cone, to a high-pressure component, comprising a bore and a connection line in the high-pressure component, wherein the bore has an internal screwthread and the end face of the bore is joined to the connection line via a conical sealing cone, further comprising a hollow pressure screw with an external screwthread which is designed to engage in the internal screwthread of the bore, wherein the pressure screw has an internal screwthread which is designed so as to engage in the external screwthread of the sensor, wherein the external screwthread and internal screwthread of the pressure screw run in opposite directions, so that the sensor sealing cone and the end face of the bore can be pressed against each other by screwing the pressure screw into the bore of the high-pressure component.

The present application incorporates by reference Provisional U.S. Application 61/531,659, filed Sep. 7, 2011.

The present invention relates to a device for connecting a sensor, which has a conical sealing cone and an external screwthread in front of the sealing cone, to a high-pressure component, comprising a bore and a connection line in the high-pressure component, wherein the bore has an internal screwthread and the end face of the bore is joined to the connection line via a conical sealing cone, further comprising a hollow pressure screw with an external screwthread which is designed to engage in the internal screwthread of the bore. The invention moreover relates to the use of the device in a chemical high-pressure production process.

Generic devices for use in high-pressure environments have been known for some time, for example for connecting a high-pressure pipe to a high-pressure component or for joining high-pressure lines. Thus a device is disclosed in U.S. Pat. No. 2,679,411 by means of which a high-pressure pipe, the end of which is designed as a conical sealing cone, can be joined in sealing fashion to a high-pressure component, wherein the high-pressure component has a bore with an internal screwthread and a conical sealing cone in the end face of the bore. The high-pressure pipe has an external screwthread onto which a pressure sleeve is screwed. A hollow pressure screw with an external screwthread and a circumferential shoulder on its inner surface is pushed over the high-pressure pipe and screwed into the internal screwthread of the bore. The sealing joint is achieved by the fact that the shoulder of the pressure screw pushes the pressure sleeve in the direction of the end face of the bore, until the conical surfaces of the sealing cones of the high-pressure pipe and high-pressure component are pressed sufficiently against each other.

A similar device for connecting a high-pressure pipe to a high-pressure component is described in the German Auslegeschrift DE 1 273 282 A1. Here too the sealing joint is effected by the interaction of a hollow pressure screw (here referred to as a gland nut) with a pressure sleeve (here referred to as a sleeve or collar). The same principle is applied in patent specification DE 197 51 138 C1 in order to produce sealing joints in an elbow piece for redirecting a high-pressure pipe.

It is a common feature of all the known generic devices that, in order to achieve sufficient contact force for the sealing, a hollow pressure screw interacts with a pressure sleeve, wherein the pressure sleeve is fastened to the end of the high-pressure pipe, and the pressure screw is screwed into a bore of the high-pressure component as a union nut.

As well as for joining high-pressure pipes to other high-pressure components, this type of device is also used to fasten rod- or tube-shaped sensors to high-pressure components in sealing fashion, for example at lens connections between two high-pressure lines. For structural reasons, in this type of application the space in which the sensor and the pressure screw need to be accommodated is often limited. The abovementioned established joining techniques are thus restricted in terms of the maximum permissible external diameter of the sensor and pressure screw. When a maximum external diameter of the pressure screw is predetermined, by virtue of strength calculations depending on the materials used and the pressure range in the high-pressure component, a maximum permissible external diameter results for the sensor. Sensors with a larger external diameter, which are desirable for many applications, cannot be used in such a case using the previously known joining techniques.

The object of the invention is to provide a device for connecting a sensor to a high-pressure component, which widens the range of uses for sensors in high-pressure applications, whilst retaining the good sealing properties of known techniques.

This object is achieved according to the invention by a device according to claim 1. Advantageous embodiments of the invention are given in the dependent claims 2 to 4. The use of devices according to the invention in a high-pressure chemical production process is the subject of claims 5 to 7.

The device according to the invention is suitable for connecting a sensor, which has a conical sealing cone and an external screwthread in front of the sealing cone, in sealing fashion to a high-pressure component. The sealing cone can form a tapering end of the sensor, similar to a high-pressure pipe, as is known from the abovementioned prior art. The sealing cone can, however, also form a conical taper as a transition between two portions of the sensor with different diameters. In this case, the external screwthread is attached to the portion with the larger diameter. Such a sensor is explained in detail below with the aid of an example.

The invention can advantageously be applied to different types of high-pressure components. A high-pressure component is understood below to be a component inside which pressures greater than 100 bar can prevail. The invention can be applied particularly advantageously to high-pressure components inside which a pressure of 325 bar to 3600 bar can prevail during operation. Examples are headers and distributors of high-pressure lines or lens connections between high-pressure lines.

The device according to the invention comprises a bore and a connection line in the high-pressure component, wherein the bore has an internal screwthread and the end face of the bore is joined to the connection line via a conical sealing cone. When connected, the sensor is joined to the connection line in order to detect a parameter in the high-pressure component, for example pressure or temperature, via the connection line.

The device moreover comprises a hollow pressure screw with an external screwthread which is designed so as to engage in the internal screwthread of the bore. According to the invention, the pressure screw additionally has an internal screwthread which is designed so as to engage in the external screwthread of the sensor, wherein the external screwthread and internal screwthread run in opposite directions, so that the sensor sealing cone and the end face of the bore can be pressed against each other in sealing fashion by screwing the pressure screw into the bore of the high-pressure component.

Because the external screwthread and internal screwthread of the pressure screw run in opposite directions, the sealing cone of the sensor can only be pressed axially onto the sealing cone in the end face of the bore. If they were to run in the same direction, the sensor would need to be rotated relative to the bore in the high-pressure component in order to generate a sufficient contact pressure, which could result in damage to the sealing surface between the two sealing cones. In a preferred embodiment of the invention, the pressure screw is first screwed onto the external screwthread of the sensor. The pressure screw is then screwed into the bore, while the sensor is secured against rotation, for example by the sensor being held with a wrench at a suitably designed engaged position so that it cannot turn.

In a preferred embodiment of the invention, the external screwthread of the pressure screw is designed as a right-hand thread and the internal screwthread is designed as a left-hand thread.

The cone angle of the sealing cone of the sensor is preferably from 75° to 81°, in particular 78°. The cone angle of the sealing cone in the end face of the bore is preferably 1° to 3°, in particular 2°, larger than the cone angle of the sealing cone of the sensor. Choosing the cone angle from the preferred range means that the proportion of the radial forces on the sensor is smaller than in the case of the known solutions with smaller cone angles. The measuring accuracy can be improved as a result of this design feature, in particular for sensors which react sensitively to external pressure influences.

The device according to the invention can advantageously be used in high-pressure chemical production processes at high pressure, in particular a pressure in the connection line of 325 to 3600 bar. The device according to the invention can be used particularly advantageously in high-pressure polymerization reactions in tube reactors, in particular to produce low-density polyethylene (LDPE). It is customary in such processes to attach sensors for detecting pressure or temperature at so-called measurement lenses. The measurement lens is a disk-shaped component which is screwed between the ends of two high-pressure lines as a flange joint. The measurement lens is provided with one or more bores for holding sensors.

For structural reasons, the thickness of the measurement lens and hence the distance between the ends of the tube lines are limited. A maximum permissible external diameter of the bore and hence of the pressure screw too is determined by strength requirements and the concrete pressure range. In the conventional method for connecting sensors to the measurement lens as a high-pressure component, two components are required, namely a pressure screw and a pressure sleeve, which must both have a minimum material thickness. The device according to the invention has the advantage that it manages with just one pressure screw, and hence reliably meets the requirements for sealing and allows a compact structure for the connection. It is thereby now possible also to connect sensors with a greater external diameter than previously to high-pressure components.

In the case of embodiments of the sensor where the sealing cone forms a conical taper between two portions of the sensor with different diameters, a larger external diameter of the sensor also allows a larger diameter of the portion after the conical taper. Whereas in the prior art, for corresponding sensors in lens connections of high-pressure lines, diameters of approximately 5 mm were known hitherto, the invention now allows the use of sensors with a corresponding diameter of 10 mm and higher. The range of sensors which can be used is thus considerably extended by the invention.

When the external diameter of the sensor is predetermined, in the device according to the invention the diameter of the bore in the high-pressure component can be designed to be smaller, which is advantageous in terms of strength considerations.

The invention is explained further below, where the drawings should be understood as schematic diagrams. They do not limit the invention, for example in terms of concrete dimensions or alternative forms of components. In the drawings:

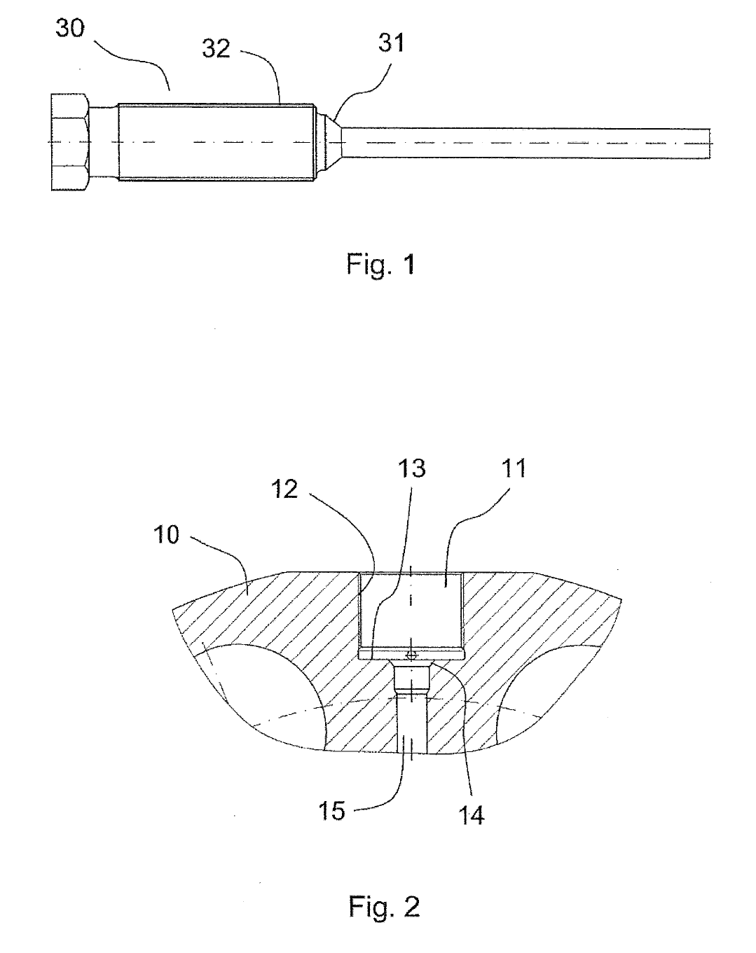

FIG. 1 shows an example of a sensor

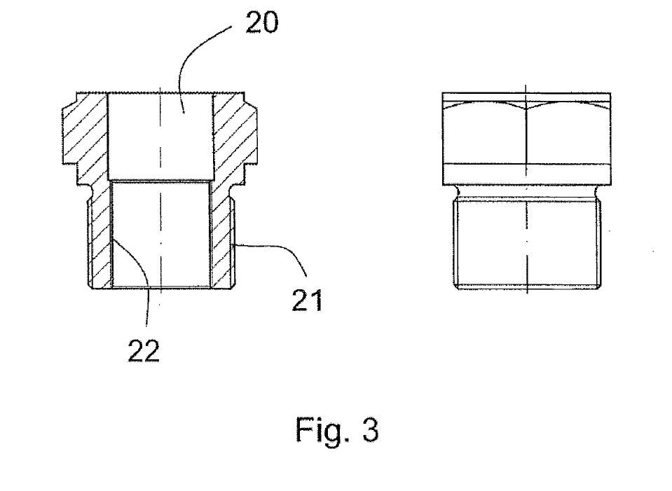

FIG. 2 shows a section of a cross-section through a high-pressure component

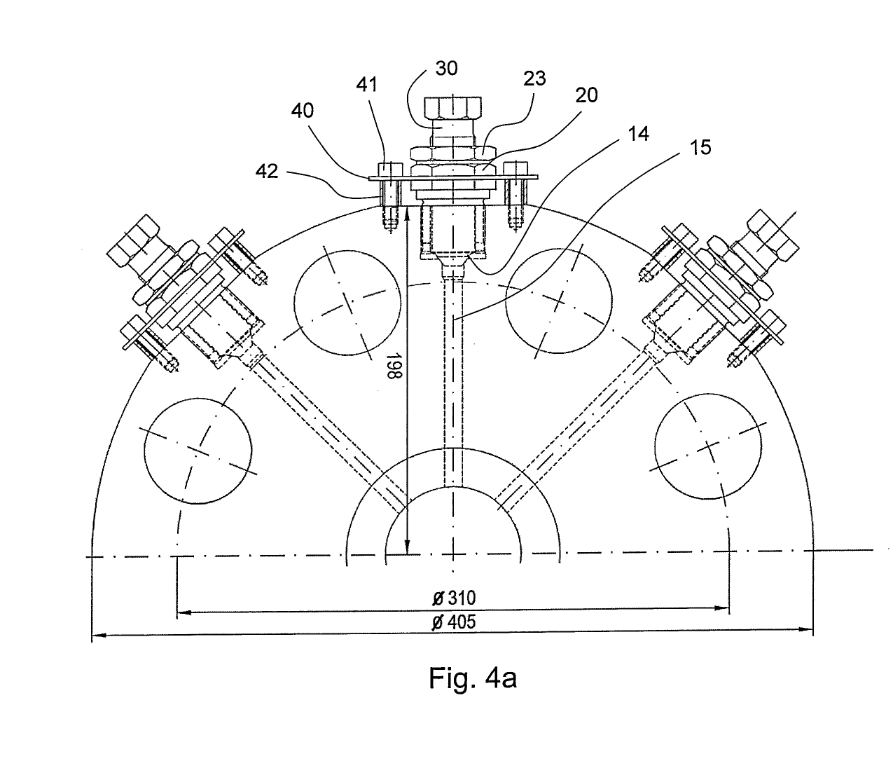

FIG. 3 shows an embodiment of a pressure screw according to the invention

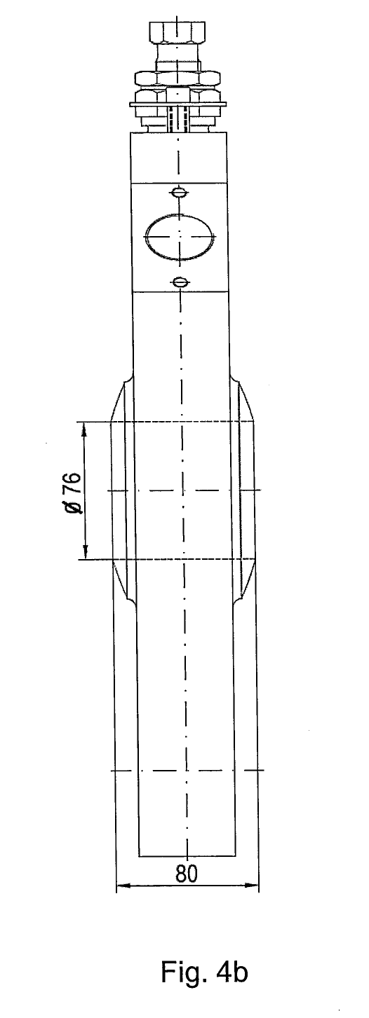

FIG. 4 shows an example of the connection of three sensors to a lens connection of a high-pressure line

In FIG. 1, an example of a rod-shaped pressure-measurement sensor 30 is shown. The sensor 30 comprises two cylindrical portions with different diameters. The two portions merge via a conical taper which is referred to as a sealing cone 31. An external screwthread 32 is present in front of the sealing cone 31 at the portion with the larger diameter. Further components of the sensor, such as a chemical seal and an electrical connection, are not shown in FIG. 1.

FIG. 2 shows, by way of example, a section of a cross-section through a high-pressure component 10. A bore 11 extends from an outer surface of the high-pressure component 10 in the direction of the inside of the component. The bore 11 is provided with an internal screwthread 12. A connection line 15 leads from the end face 13 of the bore 11 further into the inside of the high-pressure component 10. The transition from the end face 13 of the bore into the connection line 15 has a conical design as a sealing cone 14.

A preferred embodiment of a hollow pressure screw 20 according to the invention is shown in FIG. 3, on the right-hand side in a front view and on the left-hand side as a longitudinal section through the axis of the cylinder. The outer upper part of the pressure screw is designed as an external hexagon, while the lower part of the outer surface is provided with an external screwthread 21. The lower part of the inner surface is provided with an internal screwthread 22 which runs in the opposite direction to the external screwthread 21. In this example, the upper part of the inner surface is designed as a smooth cylindrical surface. However, the invention also comprises embodiments in which the whole inner surface is provided with an internal screwthread 21.

As an example of application, FIG. 4 shows the connection of three sensors 30 to a lens connection of a high-pressure line as a high-pressure component. A front view of the lens connection is shown on the left-hand side of FIG. 4, and a side view on the right-hand side, no sensor being illustrated here. Dimensions are given in millimeters. The lens connection also serves as a sealing element between two high-pressure lines, and eight holes are provided, distributed over the circumference, for the flange screwed connection. Under operating conditions, a fluid flows through the opening in the center of the lens connection at high pressure. The component is equipped with three identically designed devices for connecting sensors according to the invention. The sensors 30 correspond to the type shown in FIG. 1.

Bores extend from the outside of the lens connection in the direction of the center. The bores are provided with an internal screwthread. The end faces of the bores are joined to connection lines 15, which lead to the opening in the center of the lens connection, via sealing cones 14. A sensor 30 is in each case joined leaktightly to the high-pressure component with the aid of a pressure screw 20. In order to prevent unintentional loosening of the pressure screws, locking plates 40 are attached around the pressure screws 20 and fastened to the high-pressure component by screws 41 via spacer sleeves 42. The locking plates have a recess with a shape that corresponds to the outer contour of the pressure screws, and are hexagonal in the example. A locking nut 23 is screwed on in order to secure the sensors 30 against unintentional loosening.

1. A device for connecting a sensor (30), which has a conical sealing cone (31) and an external screwthread (32) in front of the sealing cone (31), to a high-pressure component (10), comprising a bore (11) and a connection line (15) in the high-pressure component (10), wherein the bore (11) has an internal screwthread (12) and the end face (13) of the bore is joined to the connection line (15) via a conical sealing cone (14), further comprising a hollow pressure screw (20) with an external screwthread (21) which is designed to engage in the internal screwthread (12) of the bore (11), wherein the pressure screw (20) has an internal screwthread (22) which is designed so as to engage in the external screwthread (32) of the sensor (30), wherein the external screwthread (21) and internal screwthread (22) of the pressure screw (20) run in opposite directions, so that the sensor sealing cone (31, 14) and the end face of the bore can be pressed against each other in sealing fashion by screwing the pressure screw into the bore of the high-pressure component.

2. The device according to claim 1, wherein the external screwthread (21) of the pressure screw (20) is designed as a right-hand thread and the internal screwthread (22) is designed as a left-hand thread.

3. The device according to claim 1 or 2, wherein the cone angle of the sealing cone (31) of the sensor (30) is 75° to 81°, in particular 78°, and the cone angle of the sealing cone (14) in the end face (13) of the bore (11) is 1° to 3°, in particular 2°, larger than the cone angle of the sealing cone (31) of the sensor (30).

4. The device according to claim 1 or 3, wherein the high-pressure component (10) is a header, distributor or lens connections of a high-pressure line.

5. The use of the device according to at least one of claims 1 to 4 in a chemical production process, in which a pressure of 325 to 3600 bar prevails in the connection line (15).

6. The use of the device according to at least one of claims 1 to 4 in a chemical production process, wherein the sensor (30) is a detector for pressure or temperature.

7. The use of the device according to claim 5 or 6, wherein the production process is a high-pressure polymerization reaction, in particular for producing low-density polyethylene (LDPE).
